(19) United States
(12) Patent Application Publication
(10) Pub. No.: US 2019/0029369 A1
(43) Pub. Date: Jan. 31, 2019

(54) ARTICLE OF FOOTWEAR HAVING A 3-D PRINTED FABRIC

(71) Applicant: Wolverine Outdoors, Inc., Rockford, MI (US)

(72) Inventors: Daniel J. VanWagnen, Belding, MI (US); Christopher J. Loveder, Rockford, MI (US)

(21) Appl. No.: 16/033,382

(22) Filed: Jul. 12, 2018

Related U.S. Application Data
(60) Provisional application No. 62/652,082, filed on Apr. 3, 2018.
(60) Provisional application No. 62/538,341, filed on Jul. 28, 2017.

(51) Int. Cl. A43B 23/02; A43B 1/14; A43D 11/00; D04H 3/005; B29C 64/10; B29C 64/393; B33Y 50/02; B33Y 80/00

(52) U.S. Cl. CPC A43B 23/0245; A43B 1/14; A43D 11/00; A43B 23/024; D04H 3/005; B29C 64/10; B29L 2031/505; B33Y 50/02; B33Y 80/00; A43D 2200/60; A43D 2200/00; D10B 2501/043; B29C 64/393

(57) ABSTRACT

A system and method for manufacturing an upper of the footwear by additively depositing material to form a fabric element having a plurality of threads, and incorporating the fabric element into the footwear. The plurality of threads of the fabric element may form at least one texture. Additionally or alternatively, the fabric element may be manufactured with a shape that conforms to a 3-D contoured surface.

### TECHNICAL FIELD

The present application relates to footwear or a garment, and more particularly toward an article of footwear incorporating an upper that includes a three-dimensional (3-D) printed fabric material.

### BACKGROUND

Conventional articles of footwear include an upper and a sole structure secured to a lower surface of the upper. The upper provides a void that receives a person's foot and positions the foot with respect to the sole structure. The sole structure may provide traction or cushion for the foot under a variety of conditions, e.g., walking, running or standing, or a combination thereof. Conventional uppers are formed from conventional materials, such as injection molded polymers, fabric manufactured from spooled yarn or thread, and leather or leather-like materials, that are fit and assembled about a last that provides a 3-D shape for a foot. The last may be a conventional and standard last for a line of footwear, such as a size 11 for a line of work boots. The upper may include more than one layer of materials to define an exterior layer, an intermediate layer, and an interior layer.

In many cases, multiple types of materials form sections that are joined together to form the upper. These sections may be obtained in a conventional manner by cutting the material from a larger sheet of material (e.g., a sheet of textile), injection molding techniques, and knitting or weaving a finished textile section. Synthetic or natural materials may be used in creating these sections, which are often joined and formed about the last to produce the upper. In this way, the sections are mechanically manipulated into conforming to the 3-D contour of the last. In some circumstances, a single unitary material may be used as a basis for the upper, including mechanically manipulating the single unitary material to conform to the 3-D contour of the last.

These conventional techniques and materials in many cases rely on manufacturing processes that are slow to adapt to design changes. For instance, to produce a particular design of an upper, a supply chain of materials may be established for procuring sheets of textile or creating molds to produce sections of the upper. Creating this supply chain can consume significant resources in terms of time and money before the design can be manufactured. And once manufacturing begins, the upper manufacturer is committed to producing the upper with materials from the established supply chain at the risk of loss in the investment (e.g., the upstart costs to generate a mold or purchase a significant volume of textile may be lost if efforts to produce the upper cease before stock is exhausted or the return on investment turns positive). So if the upper design is ultimately unpopular or does not sell well, the manufacturer can become exposed to significant risk.

### SUMMARY OF THE DESCRIPTION

The present disclosure is directed to a method in accordance with one embodiment including manufacturing an upper of the footwear by additively depositing material to form a fabric element having a plurality of threads, and incorporating the fabric element into the footwear. The plurality of threads of the fabric element may form at least one texture. Additionally or alternatively, the fabric element may be manufactured with a shape that conforms to a 3-D contoured surface.

In one embodiment, the method may include generating a three-dimensional model of the fabric element with digital representations of the plurality of threads. An additive manufacturing device and textile generator controller may digitally slice the three-dimensional model into a plurality of two-dimensional layers that, when stacked, form the three-dimensional model. The textile generator controller may command the manufacturing device to additively deposit the respective two-dimensional layers to form the fabric element.

The fabric element in accordance with one embodiment may include first and second areas having first and second textile configurations respectively that are different from each other. In this way, the fabric element may include areas having different textures or different appearances, or both.

In one embodiment, the three-dimensional model of the threads may be adapted according to a normal map to provide supplemental texturing to the three-dimensional model.

A footwear generation system in one embodiment may be configured to generate an article of footwear with an upper incorporating a 3-D printed fabric element having first and second areas with different texture configurations. The 3-D printed fabric element may include a plurality of threads.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 shows aspects of a footwear generation system according to one embodiment;

FIG. 2 shows a method of generating footwear according to one embodiment;

FIG. 3 shows additional aspects of the footwear generation system;

FIG. 4 shows a fabric element manufactured with the footwear generation system;

FIG. 5 shows an enlarged view of a section of the fabric element;

FIG. 6 shows a normal map according to one embodiment;

FIG. 7 shows a 3-D model of the fabric element of FIG. 4;

FIG. 8A shows a 3-D model of the fabric according to one embodiment;

FIG. 8B shows an enlarged view of a section of FIG. 8A;

FIG. 9 depicts a visual representation of a UV mapping of threads;

FIG. 10 an article of footwear incorporating the fabric element;

FIG. 11 shows an article of footwear according to one embodiment;

FIG. 12 shows a textile document for a fabric element in accordance with one embodiment;

FIG. 13 shows a textile document for a fabric element in accordance with one embodiment;

FIG. 14 shows a planar translation of a textile document in accordance with one embodiment;

FIGS. 15A, 15B show a thread module in accordance with one embodiment;

FIG. 16 shows first and second thread modules coupled to each other in accordance with one embodiment;

FIG. 17 shows a planar translation of a textile document in accordance with one embodiment;

FIG. 18 shows a fabric element in accordance with one embodiment;

FIG. 19 shows a 3-D contoured surface and a UV mapping of the 3-D contoured surface in accordance with one embodiment; and

FIG. 20 shows an enlarged view of the UV mapping in FIG. 19.

### DESCRIPTION

A method in accordance with one embodiment includes manufacturing an upper of the footwear by additively depositing material (e.g., successively depositing material) to form a fabric element having a plurality of threads, and incorporating the fabric element into the footwear. The plurality of threads of the fabric element may form at least one texture. Additionally or alternatively, the fabric element may be manufactured with a shape that conforms to a 3-D contoured surface.

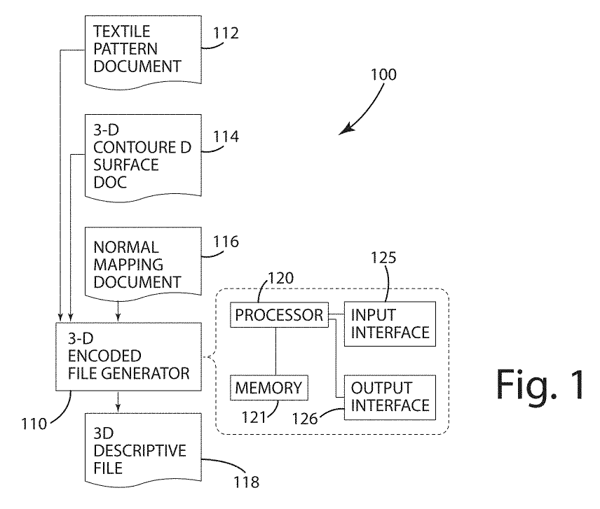

A footwear generation system in one embodiment may be configured to generate an article of footwear with an upper incorporating a 3-D printed fabric element having first and second areas with different texture configurations. The 3-D printed fabric element may include a plurality of threads. The footwear generation system in accordance with one embodiment is shown in FIG. 1 and generally designated 100. For purposes of disclosure, the footwear generation system 100 in the illustrated embodiment of FIG. 1 is depicted with several components, including a 3-D encoded file generator 110. It should be understood that the system 100 may include all or a subset of the components depicted in the illustrated embodiment. It should further be understood that the footwear generation system 100 may include any combination of the one or more components described in the illustrated embodiment along with any of the one or more components described herein. It should also be understood that although the application is described in connection with generating a fabric element for footwear, the present disclosure is not so limited. The fabric element may be incorporated into any product, including garments such as shirts.

I. 3-D Encoded File Generator

The footwear generation system 100 may include the 3-D encoded file generator 110 as depicted in the illustrated embodiment of FIG. 1. The 3-D encoded file generator 110 may be communicatively coupled to one or more data sources, including a textile pattern document 112, a 3-D model document 114 and a normal mapping document 116. The 3-D encoded file generator 110 may process and translate the one or more data sources to yield a 3-D descriptive file 118 that can be processed by a textile generator controller as commands for generating the fabric element with an additive manufacturing device. An example configuration of the 3-D encoded file generator 110 is depicted in the illustrated embodiment of FIG. 1 including one or more of the following: a processor 120, memory 121, an input interface 125, and an output interface 126. The input interface 125 may include one or more input communication interfaces, including, for example, wired communication and wireless communication capabilities. Likewise, the output interface 126 may include one or more output communication interfaces, including at least one wired interface and at least one wireless interface, or any combination thereof. The processor 120 and memory 121 may be configured to generate a 3-D descriptive file or an encoded file representative of instructions to generate a 3-D fabric element according to one or more processes described herein.

For instance, the processor 120 and memory 121 may be programmed to receive, via the input interface 125, the one or more data sources including the textile pattern document 112, the 3-D model document 114, and the normal mapping document 116, or any combination thereof. Additionally, or alternatively, the processor 120 and memory 121 may be programmed to receive user input via the input interface 125, including user input to adapt or change aspects of the one or more data sources.

The textile pattern document 112 according to one embodiment is a textile description file with a description of thread arrangements in the textile, such as a weave pattern for use on a conventional weaving machine (e.g., a jacquard loom). The textile description file may be a plaintext file, such as a WIF file with plaintext description according to the WIF specification 1.1, published Apr. 20, 1997, which is incorporated herein by reference in its entirety. File types other than WIF files may be used. The description within the textile pattern document 112 may include warp and weft sections that provide information such as default color, spacing, and thickness values for each warp and waft thread. Based on the description of the textile pattern document 112, a planar arrangement of threads may be generated. For instance, the description of the textile pattern document may identify how threads of the textile are manipulated or positioned by a machine to yield the textile. The position of each thread within a planar textile including the relative positions of two or more threads may be obtained from the textile pattern document 112. In the context of weaving, the intersection of a warp thread and a weft thread may be identified as a connection. Similar types of connections may be identified in knit textiles where two threads intersect. At each connection, or intersection between two or more threads, a Z-order or stack order of the two or more threads may be identified according to the textile pattern document 112. Whether a thread is over or under another thread may be identified for each connection. In this way, the textile pattern document 112 may identify how each thread of the textile traverses through the textile, including direction and over or under one or more other threads of the textile. It should be understood that the textile is not necessarily a basic weave (e.g., a plain weave) with crisscrossing threads that are substantially 2-D—any type of textile may be described within the textile pattern document 112 including textiles having 3-D aspects such as a spacer mesh or a spacer knit, which is a planar type of textile with one or more threads that traverse the textile from a top surface to a bottom surface. The bottom surface and the top surface in this example are separated by a distance such that one or more threads that traverse the textile are located in a void or space between the bottom surface and the top surface.

It should be understood that the textile pattern document 112 is not limiting to the realm of weaving, and that any type of thread descriptive document may be used including, for instance, a knitting descriptive document. And although described in connection with weaving and a weaving information file, it should be understood that any type of textile pattern document may form the basis for translating a patterned representation off a plurality of threads to a 3-D contoured surface 162. It should also be understood that the textile pattern document 112 may or may not define a thread configuration according to a pattern. For instance, the textile pattern document 112 may define a plurality of threads in a manner that is non-patterned. Conversely, the textile pattern document 112 may define a plurality of threads in a patterned manner. Additionally, the textile pattern document 112 may define a least one of a plurality of threads in a patterned manner and at least one other of the plurality of threads in a non-patterned manner.

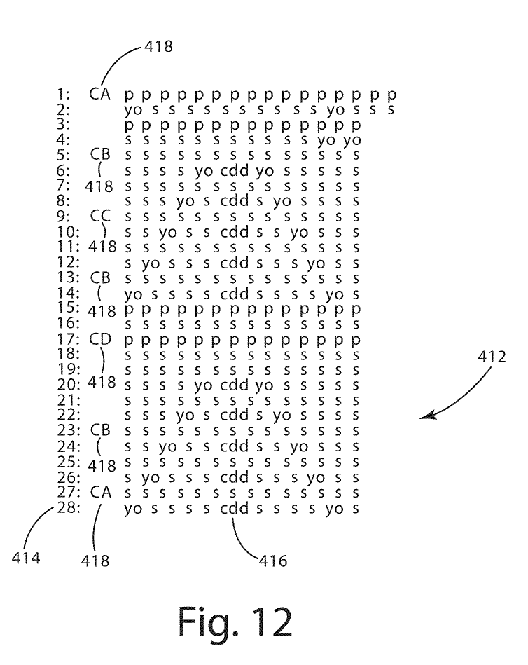

For instance, in the illustrated embodiment of FIG. 12, a textile pattern document 112 in the form of a knit pattern document is provided and generally designated 412. The knit pattern document 412 is shown as a text pattern with instructions provided in the form of a text pattern. The text pattern may comprise a plurality of characters or groups of characters that each correspond to a knit instruction. For instance, in the illustrated embodiment of FIG. 12, the knit pattern document 412 includes 28 rows designated 414, with each row 414 being defined by a plurality of stitches 416 that are identified by a text abbreviation. The text abbreviation may vary depending on the stitch type. As an example, in the illustrated embodiment, the abbreviations are defined as follows: p—purl, yo—yarn over, s—knit stitch, and cdd—center double decrease.

In the illustrated embodiment, text abbreviations may also be utilized to define yarn color for one or more rows, and are generally designated 418. The color text abbreviations 418 may designate the color for one or more stitches following the color text abbreviations 418. For instance, the color text abbreviation 418 at row 1 in the illustrated embodiment is designated CA and defines the color for stitches in rows 1-4 until another color text abbreviation is encountered. The color text abbreviations 418 in the illustrated embodiment include the following letter designations: CA, CB, CC, and CD. These letter designations correspond generally to four different colors used in the knit pattern document 412. The assignment of a color to each letter designation may be conducted according to a pattern or user selection. In one embodiment, the color text abbreviation 418 may provide context for the type of color to be assigned. For instance, the color text abbreviation 418 designated CC in the illustrated embodiment may be suggestive that a contrasting color should be assigned.

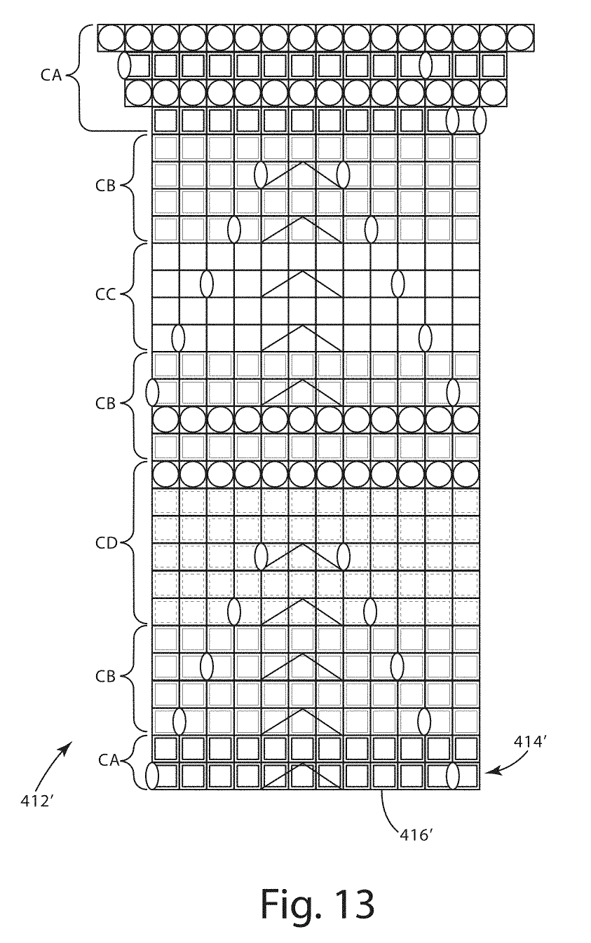

The knit pattern document 412′ in an alternative embodiment is depicted in FIG. 13 in the form of a chart instead of a text document. The chart of the knit pattern document 412′ is not limited to the type shown, and may be defined differently, such as with numbered columns and rows or with different symbols, or a combination thereof. For purposes of disclosure, and to facilitate understanding, the knit pattern document 412′ in the illustrated embodiment of FIG. 13 defines the same knitting pattern defined in the knit pattern document 412 in the illustrated embodiment of FIG. 12. Any type of thread configuration, including a knitting pattern, may be defined in the knit pattern document 412, 412′.

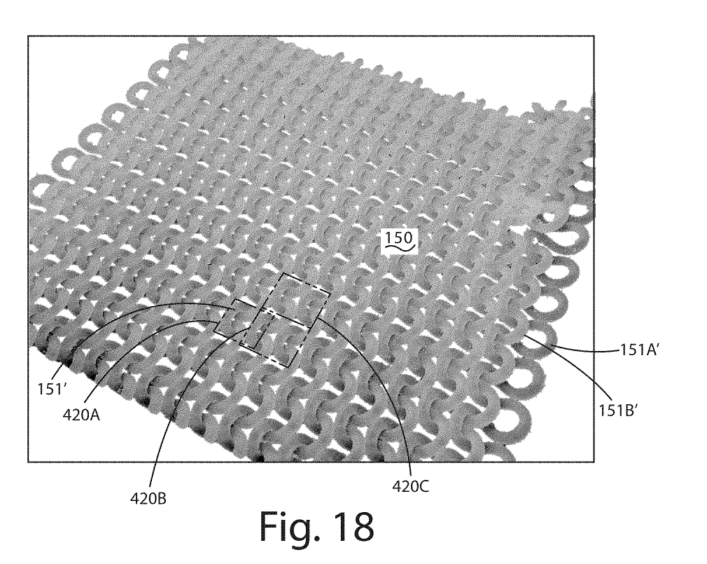

The knit pattern document 412′ in the illustrated embodiment of FIG. 13 includes a grid of stitches or stacks of stitch rows 414′. In the illustrated embodiment, a box provided for each stitch 416′, and a symbol or lack of a symbol may be indicative of the stich-type for each stitch 416. For instance, the following symbols are used in FIG. 13: O=Purl, ( )=Yarn over, Λ=Centre double decrease, and Blank=Stitch. It should be understood that these are not the only symbols that can be used in a knit pattern document 412′—additional and/or alternative symbols may be utilized. In the illustrated embodiment of FIG. 18, the textile color is identified through use of different colors (shown as varying shades of gray) and designated CA, CB, CC and CD, similar to the color designations in the illustrated embodiment of FIG. 12.

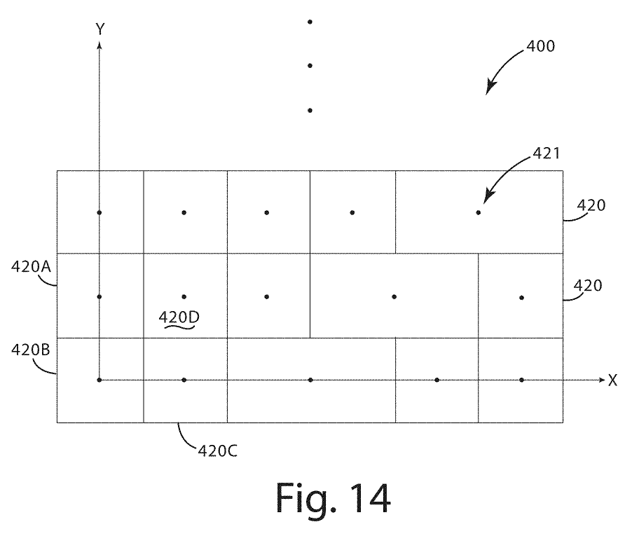

As discussed herein, the textile pattern document 112 may provide the basis for a planer fabric element. The planar fabric element may be represented as a 2-D+Stack Order translation, but the present disclosure is not so limited. As another example, as depicted in the illustrated embodiment of FIG. 14, the planar fabric element may be represented as a planar translation 400 including a plurality of thread modules 420. For purposes of disclosure, only two of the plurality of thread modules 420 are designated in the illustrated embodiment of FIG. 14—but each of the rectangular modules in the planar translation 400 may be a thread module 420. It is noted that each of the thread modules 420 is depicted as a 2-D quadrilateral shape but the thread module 420 may be a 3-D dimensional object (e.g., a quadrilaterally-faced hexahedron) within which a path of one or more threads is defined. It should also be understood that the present disclosure is not limited to a 3-D object like the one shown in FIG. 13—the thread modules 420 may be defined by any closed surface object, including a closed, curved surface object, an N-sided polygon faced polyhedron (with or without parallel sides), or a closed surface with curved and/or planar surfaces. Each of the thread modules 420 may include a locating point 421 that can be used to locate the thread module 420 to an X, Y coordinate of the planar translation 400 of the planar fabric element. In the illustrated embodiment, the plurality of thread modules 420 are depicted as similar types of objects—quadrilaterally-faced hexahedrons—but the present disclosure is not so limited. A plurality of differently shaped objects may form the planar translation 400.

A thread module 420 in accordance with one embodiment of the present disclosure is shown in FIGS. 14A-B. In the illustrated embodiment, the thread module 420 may be defined by one or more parameters that govern a position of one or more threads 422 within the thread module 420 and the way in which the one or more threads 422 of the thread module 420 interact with one or more threads 422 of an adjacent thread module 420. The thread module 420 in the illustrated embodiment depicts a thread configuration for a stockinette stitch, but the present disclosure is not so limited—the thread module 420 may define any type of thread configuration, including a stitch configuration or weave configuration or a combination thereof.

For instance, one parameter of the thread module 420 may define a location of a thread junction 432A, 432B at or near a surface of the thread module 420. The thread junction 432A, 432B may define a position at which a thread 422 of the thread module 420 is capable of joining with a thread 422 of an adjacent thread module 420. The joint at the thread junction 432A, 432B may be seamless such that the thread 422 appears to be defined as a continuous thread in the planar translation 400. The thread modules 420 may form blocks with thread junctions 432A, 432B that can be adjoined respectively with thread junctions 432A, 432B of one or more adjacent blocks. In this way, two adjacent thread modules 420 may define different thread configurations that can be joined together to form the planar translation 400 of the planar fabric element, which includes one or more threads. As mentioned herein, the textile pattern document 112 and the related planar fabric element may be based on a thread pattern, but it should be understood that a pattern is not strictly necessary to generate the planar fabric element. The textile pattern document 112 may define locations of one or more threads in an un-patterned manner.

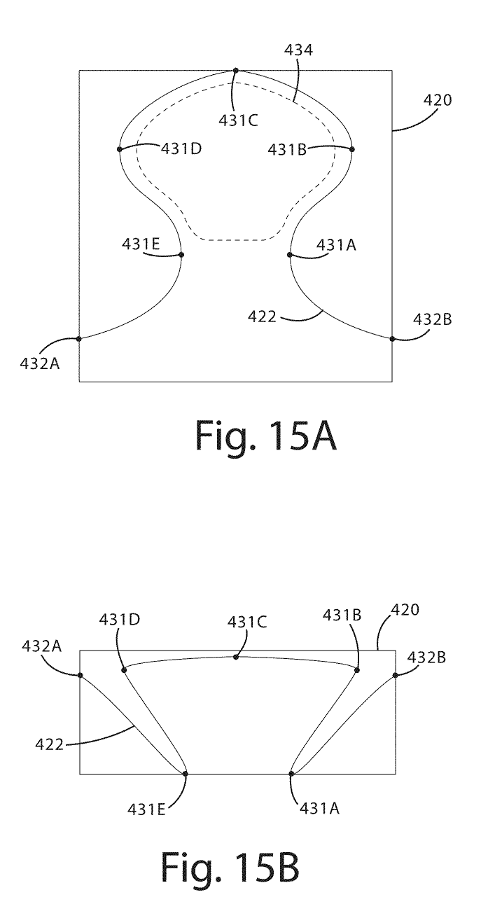

The thread module 420 may include a plurality of thread junctions 432A, 432B, such as two thread junctions 432A, 432B, for a single thread 422 as shown in the illustrated embodiment of FIGS. 15A, 15B. However, there may be more than two thread junctions 432A, 432B, which may be provided by one or more threads or thread segments. For instance, the thread module 420 may define a thread configuration with thread sections in the shape of a+, which may define thread junctions at the left, right, upper and lower sides of the +.

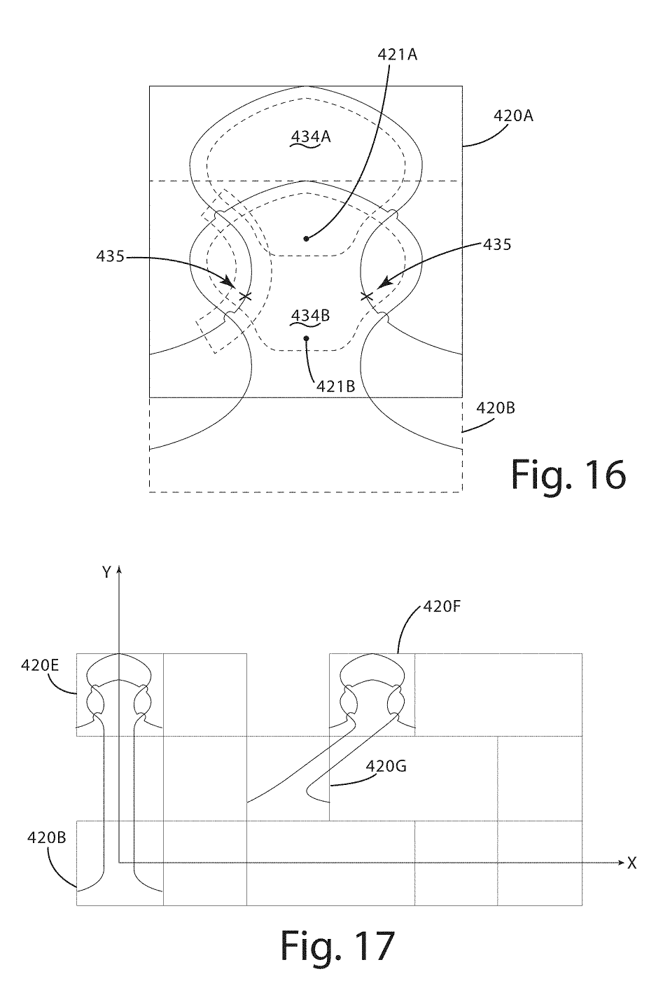

Another example of a parameter of the thread module 420 is a loop region 434 that defines a space through which the thread module 420 may accept a thread from another thread module 420 in proximity to the thread module 420. The loop region 434 of a first thread module 420 may define a surface through which one or more connecting thread segments 436 from a second thread module 420 may pass at or near a passage region 435, thereby providing a connection or interface between the first and second thread modules 420. An example of such a loop region 434 and a passage region 435 is shown in the illustrated embodiment of FIG. 16. There are first and second thread modules 420A, 420B shown in the illustrated embodiment in an adjacent relationship with a connecting thread segment 436 of the first thread module 420A passing through a passage region 435 of the loop region 434B of the second thread module 420B. It should be noted that all or portions of the first and second thread modules 420A, 420B may overlap each other. The positions 421 and the scale of the first and second thread modules 420A, 420B may be determined such that one or more threads of the first module 420A pass through the loop region 434B of the second thread module 420B at or near the passage region 435. The scale of the first thread module 420A and/or the scale of the second thread module 420B may be varied to achieve passage of the connecting thread segment 436 through the loop region 434—in some cases, the scale may be varied in different directions at different factors to allow passage of the connecting thread segment 436 through the loop region 434. For instance, the thread module 420A may be elongated and/or skewed so that the loop region 434 is aligned with a connecting thread segment 436B of the second thread module 420B. Although shown in connection with a single, first thread module 420A having two connecting thread segments 436 passing through the loop region 434 of the second thread module 420B, the present application is not so limited connecting thread segments 436 from multiple thread modules 420 may pass through the loop region 434 of the second thread module 420B.

Another example of one or more parameters associated with the thread module 420 include thread locations 431A, 431B, 431C, 431D, 431E that define a path of one or more threads or thread segments of the thread module 420. The thread locations 431A-E may facilitate scaling and/or distorting the thread module 420 to connect with one or more adjacent thread modules 420, potentially affecting the paths of the one or more threads defined by the thread module 420 in accordance with changes in position of the thread locations 431A-E.

Yet another example of one or more parameters associated with the thread module 420 include the type information for one or more threads or thread segments. Type information may include color information, size information, or identify whether a thread includes at least one of a single filament, multiple filaments, or multiple fibers, or a combination thereof. One or more threads and/or one or more thread segments of the thread module 420 may have different type information than one or more other threads and/or one or more other thread segments of the thread module 420. For instance, one thread segment may be different from another thread segment of the same thread module 420.

The textile pattern document 112 in the context of a knit pattern document 412 may be translated to a plurality of thread modules 420 to form the basis for the planar translation 400. For instance, for each stitch defined by the knit pattern document 412, a thread module 420 may be identified and positioned at a location associated with the stitch. The 3-D encoded file generator 110 may conduct this translation process based on a library of thread modules 420 stored in memory 121.

The library of thread modules 420 may include thread modules for various types of stitches, including, for instance, stockinette stitch as shown in the illustrated embodiment of FIGS. 15A and 15B. Examples of other types of stitches include faggoting, garter stitch, reverse stockinette stitch, seed stitch, and tricot. A plurality of thread modules 420 may be arranged to form a thread arrangement, such as a thread pattern. The thread pattern in one embodiment may include a knit pattern that appears similar in thread arrangement to one or more mechanically knitted fabrics, such as fabrics knitted according to at least one of intarsia, fair isle, slip-stich color, and double knit.

In one embodiment, thread modules 420 are not limited to a particular stitch, and may include multiple types of stitches in a thread arrangement. For instance, the thread modules 420 may be utilized in conjunction with each other to form a thread arrangement that forms the basis of a fabric element 150, 150′ with one or more types of thread configurations. An example of a fabric element with a single type of thread configuration is depicted in the illustrated embodiment of FIG. 20.

The 3-D encoded file generator 110 may identify a thread module 420 based on one or more stitches defined by the knit pattern 412. A first thread module 420 may be located in X, Y space with respect to the planar translation 400 in accordance with the knit pattern 412, and may be coupled to a second thread module 420, which may be adjacent to the first thread module 420. This arrangement is depicted in the illustrated embodiment of FIG. 17 with respect to the planar translation 400.

The coupling between the first and second thread modules 420 may vary in accordance with the positional relationships of the first and second thread modules 420 and their respective thread configurations. In one embodiment, the thread modules 420 may be scaled in size and/or direction to facilitate coupling to another thread module 420 (e.g., the loop height may be increased).

For instance, in the case of first and second thread modules 420A, 420B being stockinette stitches (similar in some respects to the thread modules 420A, 420B in the illustrated embodiment of FIG. 16) and the first and second thread modules 420A, 420B being displaced along the Y-Axis relative to each other, the connecting thread segments 436 of the first thread module 420A may be disposed to pass through the loop region 434 of the second thread module 420B. In this way, the first thread module 420A may couple to the second thread module 420B.

In an alternative embodiment, with the first and second thread modules being displaced along the X-Axis relative to each other, such as in the case of thread module 420B being the first thread module and thread module 420C being the second thread module. In this case, the thread junction 432B of the first thread module 420A may be joined with the thread junction 432A of the second thread module 420C.

In another alternative embodiment, the first and second thread modules may be displaced along the X-Axis and the Y-Axis relative to each other, such as in the case of thread module 420G being the first thread module and thread module 420F being the second thread module. The connecting thread segments 436 of the second thread module 420F and/or the loop region 434 of the first thread module 420G may be extended or scaled (by scaling the first and/or second thread modules 420F, 420G) so that the connecting thread segments 436 of the second thread module 420F pass through the loop region 434 of the first thread module 420G. This type of connection may be utilized in cases where the nearest adjacent thread module to the first thread module 420G is not disposed directly above or below (e.g., displaced only along the Y-axis relative to the first thread module 420B), such as if thread module 420A were absent in the illustrated embodiment of FIG. 14.

In yet another alternative embodiment, the first and second thread modules 420 may be displaced along the Y-Axis relative to each other, but with one or more other thread modules 420 disposed in a gap between the Y-Axis positions as shown in the illustrated embodiment of FIG. 17 The thread module 420B and/or the thread module 420E in the illustrated embodiment may be scaled to connect with each other so that the connecting thread segments 436 of the thread module 420E pass through the loop region 434 of the thread module 420B. The thread modules 420 may be scaled in size and/or direction to facilitate coupling to another thread module 420.

In one embodiment, the textile pattern document 112 may represent the plurality of threads according to a generally flat or planar textile or as a 3-D shaped textile (e.g., a 3-D knit structure). The arrangement of threads according to the textile pattern document 112 may or may not form a repeatable pattern. The arrangement of threads may vary in density from one area of the textile to another according to the textile pattern document 112. It should further be understood that the threads themselves may be represented as monofilaments but are not so limited. For instance, each thread may be formed of more than one filament, which may or may not have the same length. The threads may be formed of fibers mapped into digital space similar to a 3-D digital representation of a natural yarn. The threads may vary in diameter from one thread to another thread, or along a thread from one end to the other, or a combination thereof. The color of the threads may also vary from one thread to another, or along the thread, or a combination thereof. As discussed herein, a physical manifestation of the threads may be generated by the additive manufacturing device 130.

The textile pattern document 112 may provide the basis for a planar fabric element (e.g., two-dimensional (2-D)) having a plurality of threads (e.g., warp and weft) arranged according to a pattern described in the textile description file. At each intersection between warp and weft threads, the weft thread is over or under the warp thread according to the textile description file. As a result, the textile description file may provide a description of a planar fabric element with threads that can be physically described in terms of X-Y coordinates and a third parameter indicating whether a thread is over or under one or more intersecting threads. For instance, a thread of the planar fabric element may be described by a plurality of intersection points (X, Y coordinates) where, at each point, the thread is either over or under an intersecting thread. This planar translation of the textile description file may be considered a 2-D+Stack Order translation of the textile pattern document 112 and may be processed by the 3-D encoded file generator 110 in order to setup a translation according to a UV mapping to a 3-D contoured surface 162.

The textile pattern document 112 may define a textile having more than one type of weave or stitch configuration, and more than one type of thread. For instance, the 2-D+Stack Order translation according to the textile pattern document 112 and/or the planar translation 400 may include first and second areas having first and second weave or stitch configurations that are different from each other. In a more specific example, the first area may include at least a first configuration of a weave configuration and a stitch configuration, and the second area may include at least a second configuration of a weave configuration and a stitch configuration. The first configuration may be different from the second configuration, including where the first configuration includes a stitch configuration and the second configuration includes a different stitch configuration, or where the first configuration includes a weave configuration and the second configuration includes a different weave configuration.

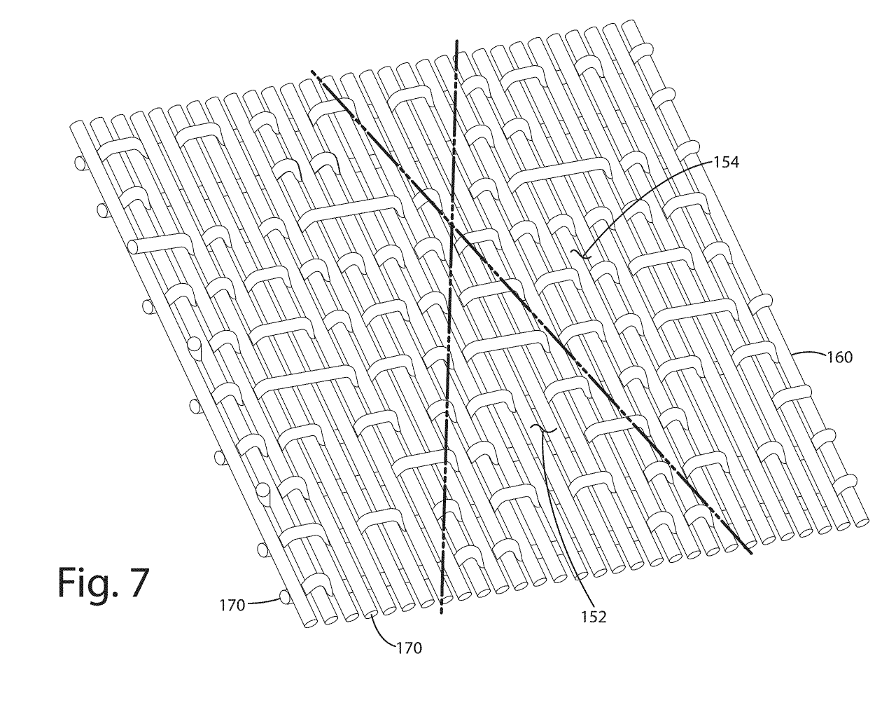

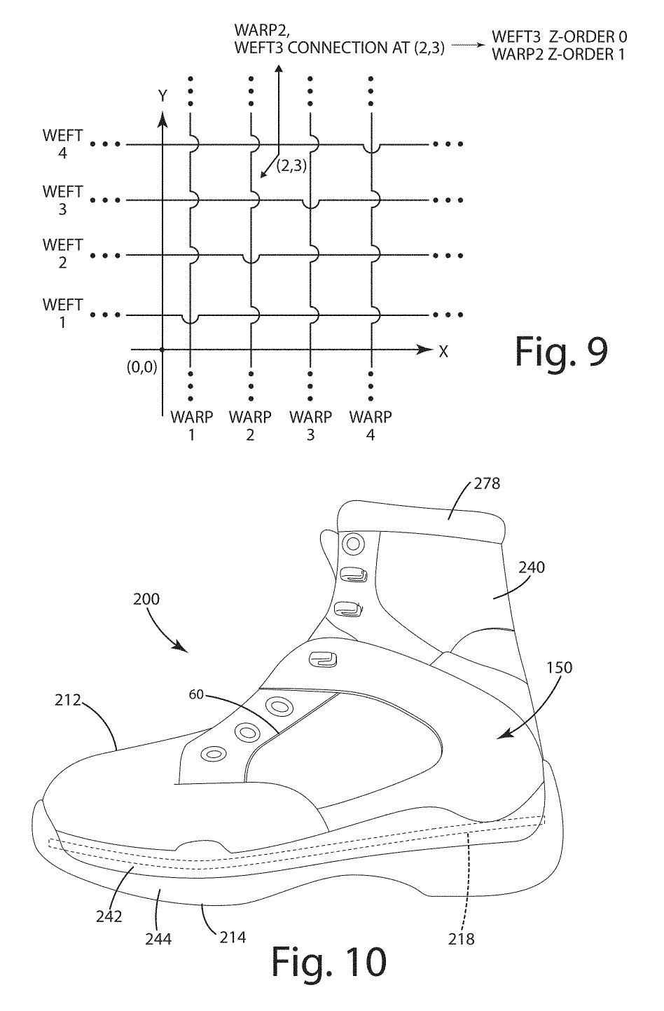

In one embodiment, the 2-D+Stack Order translation may include X-Y coordinates for each of a plurality of connections that exist among the plurality of threads described in accordance with the textile pattern document 112. Each of these X-Y coordinates may be associated with a stack order for the two or more threads intersecting at the X-Y coordinate. In other words, for each connection among a plurality of threads in a textile, there is an X-Y coordinate mapped to a stack order for the plurality of threads at that connection. The illustrated embodiments of FIGS. 7 and 9 depict a visual representation of this mapping according to one embodiment. In the illustrated embodiment, each intersection or connection between warp and weft threads of a textile is identified at an X-Y coordinate and a stack order of the threads intersecting at the connection. At X-Y coordinate (2, 3), the Warp Thread 2 and Weft Thread 3 intersect with the Warp Thread 2 being above or over the Weft Thread 3. This stack order can be represented by a Z-order value for each thread at the connection coordinate, where a first Z-order value less than a second Z-order value is indicative of the first Z-order value being beneath or under the second Z-order value in the stack order. For instance, the Weft Thread 2 is associated with a Z-order value of 0, which is beneath the Warp Thread 2 with a Z-order value of 1. It should be understood that the stack order is not limited to this type of description, and that any type of description of the stack order may be utilized, including, for example, a “+” or “−” identifier. For purposes of disclosure, the 2-D+Stack Order translation is described in connection with an X-Y coordinate system. As will be described herein, U-V or UV coordinate designations may be used in place of X-Y to avoid confusion when mapping to 3-D space, which is identified with X, Y, Z coordinates.

Additionally, or alternatively, the planar translation 400 may provide information for thread locations generally within an X-Y coordinate system with Z-axis information included to identify relative locations of one or more threads within a planar fabric element. For instance, as described herein, the planar translation may include a plurality of thread modules 420 defined at X-Y coordinates within the planar translation—each thread module 420 may include X, Y, Z information relating to locations of one or more threads within the thread module 420 so that the one or more threads may be coupled to one or more threads of one or more adjacent thread modules 420 (such as by a thread junction or a loop connection). In this way, the planar translation 400 may define locations of one or more threads to define a planar fabric element, which has a thickness associated with Z-Axis information defined by the one or more thread modules 420.

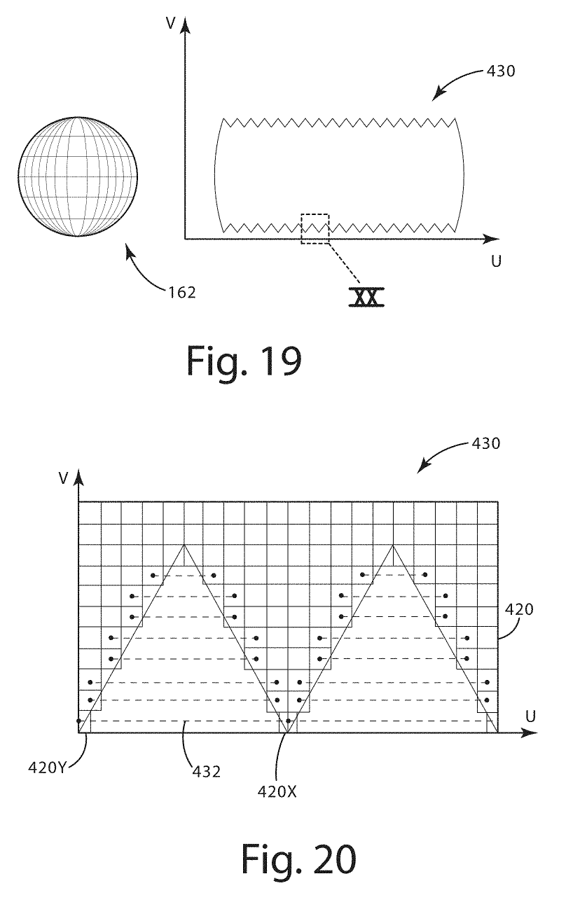

The planar translation 400 may be translated to a U-V coordinate system. In one embodiment, this translation to the U-V coordinate system may include defining connections between thread modules 420 that do not appear adjacent in the U-V coordinate system but are adjacent to each other in the 3-D contoured surface 162. For instance, in the illustrated embodiments of FIGS. 19 and 20, an example of the 3-D contoured surface 162 is shown in the form of a sphere. Next to the sphere is a UV mapping of the sphere designated 430. The UV mapping 430 in the illustrated embodiment, as discussed herein, may include a plurality of vertices corresponding to those of the 3-D contoured surface 162. The UV mapping 430 in the illustrated embodiment is defined to include a plurality of thread modules 420, which may be connected to an adjacent thread module 420 via at least one of a thread junction, a loop connection, and an overlapping intersection.

The UV mapping 430 and a plurality of thread modules 420 are shown in further detail in the illustrated embodiment of FIG. 20, which shows an enlarged section of the UV mapping 430 in FIG. 19. The thread modules 420 in this embodiment are shown in a grid form with adjacent thread modules 420 connected to each other. As discussed herein, the UV mapping 430 may define thread modules 420 that appear separated from each other but are connected in the 3-D contoured surface 162. Two such thread modules are designated in the illustrated embodiment as first thread module 420X and second thread module 420Y. These two thread modules 420X, 420Y may be connected together in an adjacent relationship and form part of the lowermost part of the sphere depicted in FIG. 19. Although the first and second thread modules 420X, 420Y may be connected together in the sphere in FIG. 19, in the UV mapping 430, the first and second thread modules 420X, 420Y are depicted separated from each other. The connection between the first and second thread modules 420X, 420Y and the connections between other adjacent thread modules shown separated in the UV mapping 430 are depicted with connection lines 432. For purposes of disclosure, some but not all of the connection lines 432 between adjacent thread modules 420 are shown in the illustrated embodiment. In one embodiment, the connection lines 432 may facilitate connecting stitch configurations defined by the thread modules 420.

The UV mapping 430 and the thread modules 420 may facilitate generating a 3-D contoured surface 162 with thread modules 420. The 3-D contoured surface 162 may be defined in terms of a plurality of threads or thread segments that can be joined in a variety of ways, including loop connections similar to mechanical knitting. In one embodiment, the 3-D contoured surface 162 may include a plurality of thread modules 420 that define knitting stitch configurations that together model at least a part of the fabric element 150, 150′, which can be generated based on the model with additive manufacturing. In this way, all or some of the fabric element 150, 150′ may be produced without mechanical knitting, but is structurally similar or the same as a mechanically knitted fabric and appears and performs similar or the same in many respects to mechanically knitted fabric.

In one embodiment, the UV coordinate system itself may be distorted prior to or as part of the UV mapping to X, Y, Z coordinates in 3-D space. This process may be identified as distortion correction and may facilitate evening out a pattern in the textile as UV mapping to the 3-D contoured surface 162.

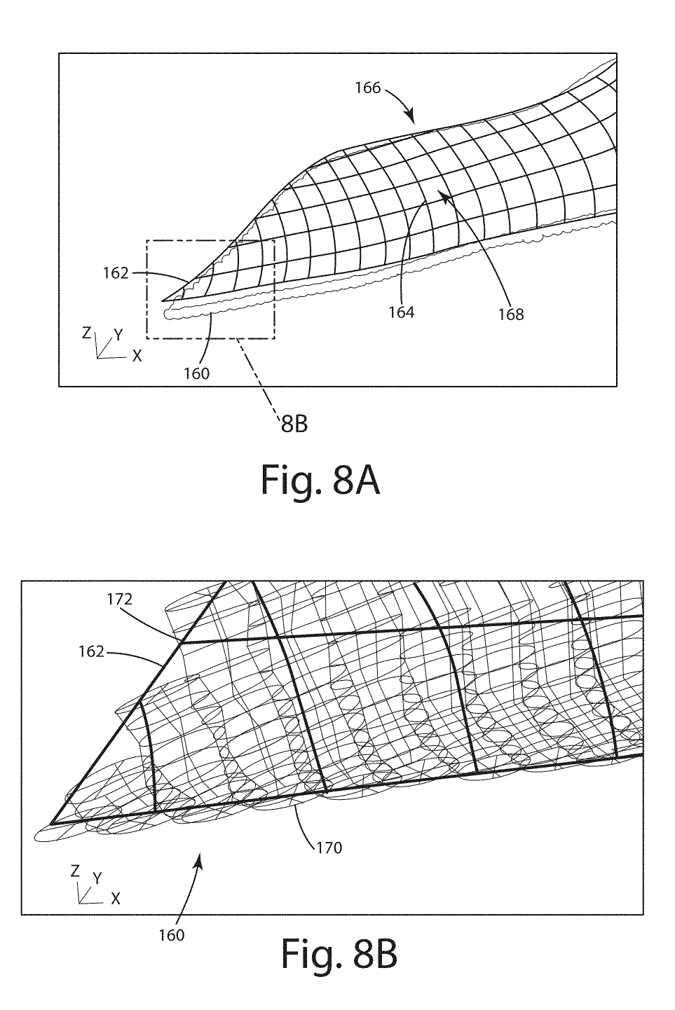

The 3-D model document 114 may provide a description of a 3-D contoured surface 162, shown in FIGS. 8A, 8B, corresponding to an aspect of footwear or a garment for which a fabric element is to be generated. The 3-D model document 114 may provide the basis for computer modeling of a three-dimensional solid aspect of the footwear or garment. As an example, the three-dimensional computer model may represent a solid model for the upper of the footwear, including the curved surface of the toe box of the upper. The solid model of the upper may include one or several layers of material represented in memory of the 3-D encoded file generator 110 (e.g., in graphical memory). The three-dimensional computer model may be based on a polygon mesh 166 with vertices 164 identifiable in 3-D space according to X, Y, Z coordinates. Each vertex 164 of the polygon mesh 166 may be associated with an X, Y, Z coordinate so that a plurality of polygons 168 of the polygon mesh 166 may define the three-dimensional solid model in 3-D space. A variety of encoding schemes may be utilized for saving the mapping between the polygon mesh 166 and the X, Y, Z coordinates, including for example saving a UV mapping of the polygon mesh 166 in 2-D (UV coordinates) to the 3-D space (X, Y, Z coordinates).

The 3-D encoded file generator 110 may be configured to process the planar translation, including the 2-D+Stack Order translation, of the textile description file for an aspect of the footwear, such as a section of the upper or a unitary upper. For instance, an aspect of the footwear may be selected for manufacture as a fabric element, and the 3-D contoured surface associated with the aspect may be used as a basis for UV mapping the planar translation 400, including the 2-D+Stack Order translation of a textile description file (e.g., a weaving information file).

Each thread of the planar translation 400, such as the 2-D+Stack Order translation, may be UV mapped to the 3-D contoured surface 162. In this way, each thread of the textile may be represented as a 3-D solid model in 3-D space that is positioned relative to other threads in the textile according to the planar translation 400, including the 2-D+Stack Order translation. As an example, in the illustrated embodiment of FIG. 8B, each thread of the textile may be represented as a filament 170 (e.g., a curved filament) in the 3-D space that, at each intersection with one or more other threads, is respectively over or under the one or more other threads relative to the 3-D contoured surface 162. This 3-D solid model of the plurality of threads may be output to a 3-D model document different from the 3-D model document 114 that was used as a basis for mapping the planar translation 400, such as the 2-D+Stack Order translation, of the textile description file. The 3-D solid model of the plurality of threads arranged to conform to a 3-D contoured surface 162 and a textile description file may be considered a 3-D fabric element model 160, designated as such in the illustrated embodiment of FIG. 7 and the illustrated embodiments of FIGS. 8A, 8B in conjunction with the 3-D contoured surface 162.

In one embodiment, each of the UV coordinates of the planar translation 400, such as the 2-D+Stack Order translation, for a given thread may be mapped to 3-D space according to the contour of the 3-D solid model. For each connection or intersection of a thread, the UV coordinate of that connection may be mapped to a coordinate in 3-D space. The thread may be defined at this coordinate in 3-D space by a wire frame representative of the cross-section of the thread (e.g., one or more of oval, regular, irregular, or polygon shaped, which may vary over the length of the thread), such as the wire frame representations of the curved filament 170 depicted in the illustrated embodiment of FIG. 8B. For instance, if the thread is circular, a ring frame 172 may be disposed at the coordinate in 3-D space and oriented such that a normal vector to the plane defined by the ring frame 172 is aligned with the path of the thread at the connection point.

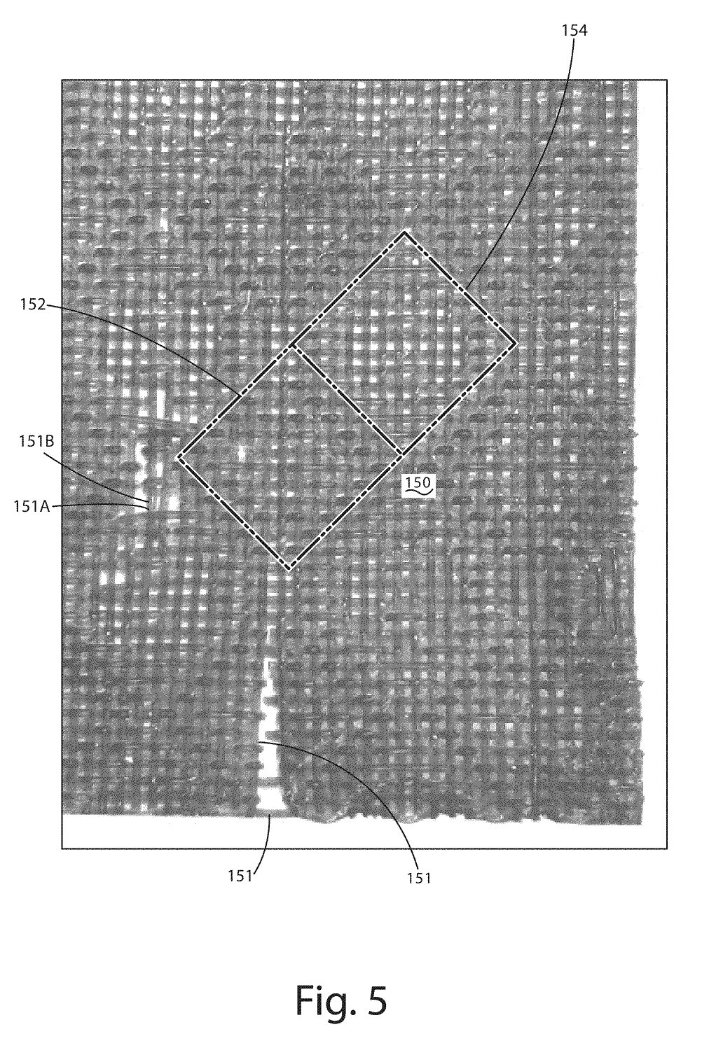

In one embodiment, the ring frame 172 may be disposed relative to one or more other threads at this coordinate according to the Stack Order of the thread. If there are two threads at the connection point, and both have circular cross-sections, the two threads may be represented by two rings frames 172 at the coordinate in 3-D space, one located above the other according to the Stack Order, and each facing the path of the respective threads. Alternatively, all or a portion of the two or more threads at the intersection may overlap with each other in the 3-D solid model so that, in the 3-D printed version, the two threads are physically joined. Examples of an intersecting configuration are depicted in the illustrated embodiment of FIGS. 5 and 9. For purposes of disclosure, each thread of the 2-D+Stack Order translation is described with a wire frame representation at each connection point that is UV mapped to 3-D space on the 3-D solid model. It should be understood that the threads may be represented differently, and may be shown, for example, as individual solid model elements or tubular elements representative of each thread.

A method according to one embodiment may utilize CAD data for an automated weaving or knitting machine to generate a 3-D model replicating the thread arrangement of any weave or knit. This 3-D model may then be printed on a 3-D printing machine, using various types of filament, in order to replicate the look, and feel, of the woven or knit textile. The weave or knit pattern can also be deformed to follow the shape of a pre-existing 3-D model. For instance, a shoe upper can be used as a base, in order to generate the thread pattern and textile information for a sheet of continuous fabric. The fabric may be cut to size or generated as a finished piece that may be incorporated into the footwear with little or no modification.

The 3-D encoded file generator 110 according to one embodiment may be optionally configured to provide supplemental texturing to the 3-D fabric element model. A variety of techniques may be utilized for generating the supplemental texturing, including, for example, one or more of displacement mapping, bump mapping, and normal mapping. Bump mapping may involve modification of the surface appearance by making it appear bumped up or down on one axis—but this modification may affect only the appearance of the surface in respect to surface lighting or how a shadow will appear if cast across a 3-D surface. The surface, itself, may not change with bump mapping.

Displacement maps may involve a higher resolution of a bump map, and affect the position or surface height of the surface. Displacement maps generally include the same information as a bump map, and are considered interchangeable. This means the bump map may be used for a displacement map, or a displacement map may be used for a bump map, with similar results being achieved for both with an insignificant difference in quality.

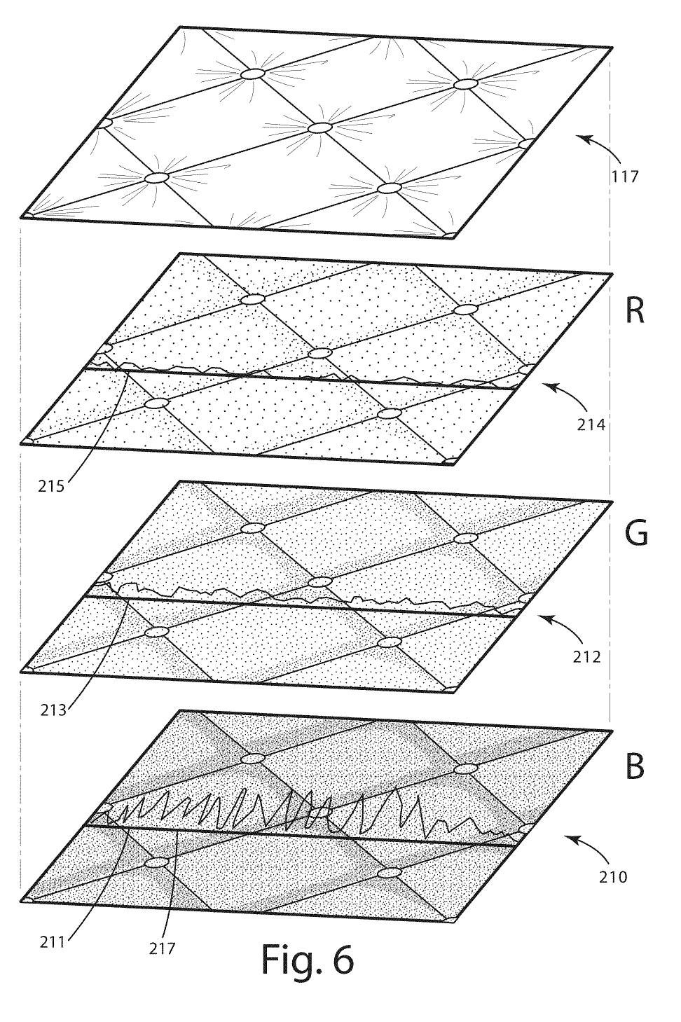

As discussed herein and shown in the illustrated embodiment of FIG. 6, a normal map 117 may carry bump map information in the Blue (Z) channel 210 as well as information in the Red (X) channel 214 and the Green (Y) channel 212. Bump or displacement maps may in one embodiment utilize the Blue (Z) channel 210 as a basis for surface modification but ignore changes or information in the Red (X) channel 214 and the Green (Y) channel 212.

For purposes of disclosure, the illustrated embodiment is described in conjunction with normal mapping. In many cases, the 3-D contoured surface 162 associated with the aspect of footwear is an un-textured, generally smooth surface. Alternatively, the 3-D contoured surface 162 may include texturing but the footwear design calls for additional or supplemental texturing. The normal map 117 may be used as a basis for adapting the 3-D fabric element model to include the supplemental texturing. The normal map 117 may be an RGB (red-green-blue) image where the RGB components correspond to X, Y, and Z coordinates of the surface normal at the UV coordinate of each pixel of the image. Each pixel location according to the UV coordinate system may be mapped to the 3-D contoured surface 162 in 3-D space with X, Y, Z coordinates. The RGB values associated with the pixel may indicate a relative change or perturbation in the surface normal of the 3-D contoured surface at the X, Y, Z coordinate. The RGB values may map as follows:
X: −1 to +1: Red: 0 to 255;
Y: −1 to +1: Green: 0 to 255; and
Z: 0 to −1: Blue: 128 to 255.

The illustrated embodiment of FIG. 6 depicts RGB values for each of Red, Green, and Blue Channels 214, 212, 210 for strips 211, 213, 215 of common pixels in each channel, with intensity for each strip 211, 213, 215 represented as height relative to a baseline 217. Because the normal map 117 in the illustrated embodiment is primarily blue, the height or intensity of the pixels in the blue channel strip 211 are significantly greater than the height or instensity of the pixels in the red and green channel strips 213, 215.

The RGB values may define a surface normal that can be used as a basis for perturbing the surface normal at a UV mapped location in X, Y, Z coordinates of the 3-D contour surface 162. A scaling factor may be applied to the surface normal defined by the RGB values to enhance or embellish the texture mapping defined by the normal map 117. For instance, a factor of 1.5 may be applied to the surface normal of the normal map 117 to increase the rate of change for surface textures across a surface, thereby embellishing the surface textures.

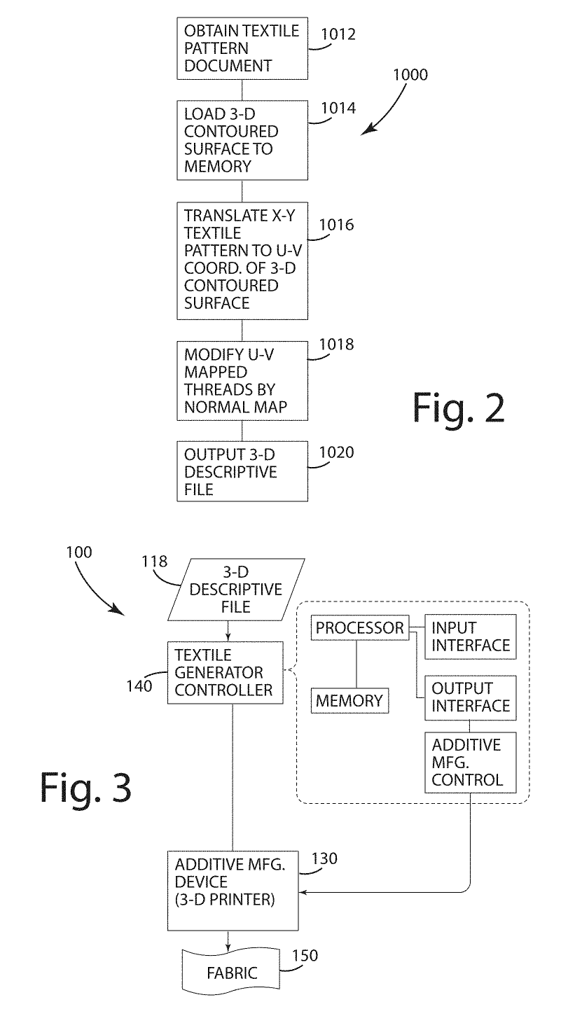

A method of generating the 3-D fabric element model 160 and the 3-D descriptive file 118 according to one embodiment is shown in FIG. 2, and generally designated 1000. The method 1000 may be performed entirely or in part by the 3-D encoded file generator 110, and may include obtaining the textile pattern document 112. Step 1012. The 3-D encoded file generator 110 may load the 3-D model document 114 into memory 121 along with the textile pattern document 112. Step 1014. The textile pattern document 112 and associated representation of threads according to X-Y coordinates may be translated to UV coordinates of a 3-D contoured surface 162 defined by the 3-D model document 114 to form the 3-D fabric element model 160. Step 1016. Optionally, the 3-D fabric element model 160 may be modified with supplemental texturing according to a normal map 117. The normal map 117 may include RGB components indicative of texturing, such as raised or lowered features or patterned aspects. Step 1018. The 3-D fabric element model 160 may be translated to a 3-D descriptive file capable of being used to generate a physical manifestation of the 3-D fabric element model 160 with the additive manufacturing device 130. Step 1020.

II. Textile Generator and Additive Manufacturing Device

As discussed herein, the 3-D fabric element model 160 may be translated by the 3-D encoded file generator 110 to output the 3-D descriptive file 118, which can be used to manufacture the 3-D fabric element model with the additive manufacturing device 130. In the illustrated embodiment of FIG. 3, the 3-D descriptive file 118 is provided to a textile generator controller 140 communicatively coupled to the additive manufacturing device 130. The textile generator controller 140 may be configured in a manner similar to the 3-D encoded file generator 110, including a processor, memory, input interface, and output interface. The output interface of the textile generator controller 140 may include an additive manufacturing controller configured to direct operation of the additive manufacturing device 130.

The additive manufacturing device 130 that generates a physical manifestation of the 3-D fabric model 160, referred to as the fabric element 150, 150′, may include any 3-D printer having a build volume suitably sized for the 3-D fabric model. Example 3-D printers include, without limitation, the Replicator 2 available from MakerBot Industries of Brooklyn, N.Y., the Cube available from 3D Systems of Rock Hill, S.C., the Solidoodle 2 available from Solidoodle LLC of Brooklyn, N.Y., the Lulzbot available from Aleph Objects, Inc. of Loveland, Colo. and the Connex 500 from Stratasys. The resolution of deposition for the additive manufacturing device 130 may be approximately 0.8 mm, preferably better than 0.5 mm, and more preferably equal to or better than 0.01 mm.

The selected 3-D printing material can include any material providing the desired material properties, including, for example, tear strength for the fabric element or tensile strength for the fabric element, or a combination thereof. Additional or alternative examples of material properties include strength, melting temperature, and coefficient of thermal expansion. Example materials include, without limitation, thermoplastic materials (such as acrylonitrile butadiene styrene (ABS) and polylactide (PLA)), water soluble material, fibrous material, waste material, metals (such as alloys), composites and combinations of the foregoing. The material used to generate the fabric element 150, 150′ may be generally malleable and flexible so that the footwear and garment is durable for continued wear and use. Other thermoplastic materials and non-thermoplastic materials can be used in other embodiments where desired. Optional post production techniques include sanding, acetone washes, and/or decaling. In one embodiment, the fabric element 150, 150′ may be manufactured with at least two materials, one of which is soluble with respect to an agent (such as a lye or sodium hydroxide solution). The soluble materials may be removed in a post processing step in order to leave voids between threads of the fabric element 150, 150′. The remaining materials may be insoluble with respect to the agent so that the remaining material forms the fabric element 150, 150′. In one embodiment, the two materials may be the same type of material, but one is cured and the other is uncured so that the uncured material remains soluble with respect to the agent.

Using the additive manufacturing device 130, aspects of the fabric element 150, 150′ may be generated through successive deposition of the material until the fabric element 150, 150′ is complete. The successive deposition process may enable generation of fabric element 150, 150′ contoured to conform to the 3-D contoured surface 162 of the 3-D model defined by the 3-D model document 114. The fabric element 150, 150′ may be incorporated into a portion of the footwear, such as the upper.

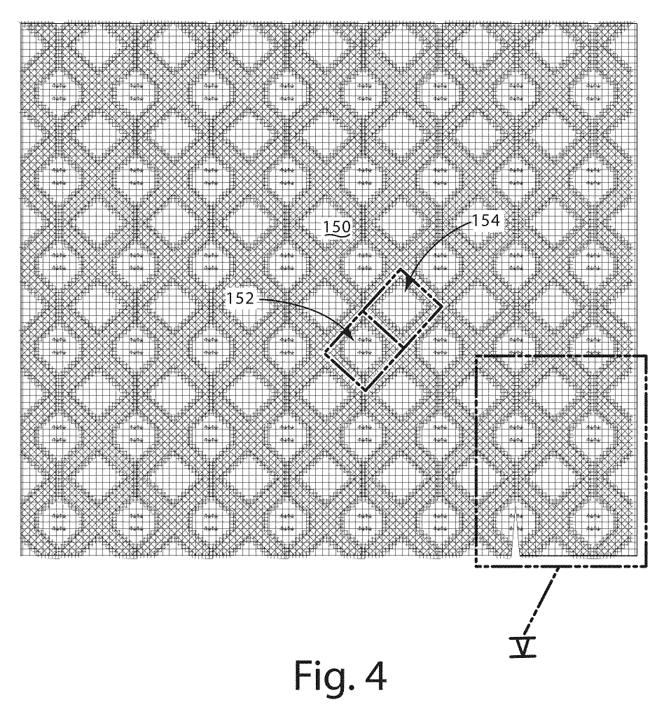

An example physical manifestation of the 3-D fabric model 160 from FIG. 7, described herein as a fabric element 150, 150′, with no supplemental texturing and mapped to a flat surface is shown and described in connection with the illustrated embodiment of FIGS. 4-5 and 18. As can be seen, the fabric element 150, 150′ may include first and second areas 152, 154 with first and second texture configurations that are different from each other. For instance, the first area 152 may include a first stitch or weave configuration, and the second area 154 may include a second stitch or weave configuration different from the first stitch or weave configuration. The first and second areas can be seen in the illustrated embodiment of FIG. 7 due to variations in the stack order of intersecting filaments 170 in the digital model, as physically manifested in the fabric element 150, 150′.

The threads 151 in the first and second areas 152, 154 may be arranged based on the translation of the textile pattern document 112 to the 3-D contoured surface defined by the 3-D model document 114, optionally textured according to the normal mapping document 116. The arrangement may include a weaving pattern or a knitting pattern defined by the textile pattern document 112.

In the illustrated embodiment of FIG. 5, a tear in the fabric element 150 is provided for purposes of disclosure to emphasize threads 151 present in the fabric element 150. In the illustrated embodiment, there are a plurality of threads 151 that are physical manifestations of the plurality of filaments 170 of the 3-D fabric model 160. Alternatively, the 3-D fabric element 160 and its physical manifestation as the fabric element 150 may be defined by a single, continuous filament 170 with a single, continuous thread 151.

In the illustrated embodiment, where a first one of threads 151A intersects a second one of threads 151B, the first thread 151A is disposed above the second thread 151B according to the stack order defined in the thread pattern document 112. As can be seen in the illustrated embodiment, in accordance with the thread pattern document 112, by defining whether a thread 151 is over or under another thread 151 at an intersection, and defining a plurality of intersections, a pattern of threads 151 may be physically manifested from the thread pattern document 112 and shaped according to the 3-D contoured surface 162. In one embodiment, as shown in FIGS. 4, 5, and 7, first and second areas 152, 154 may form a repeated pattern throughout the fabric 150 as defined by the thread pattern document 112.

In the illustrated embodiment of FIG. 18, the fabric element 150′ is defined in accordance with a thread pattern document 112, which includes a plurality of a knit stockinette stiches. The fabric element 150′ includes a plurality of threads, such as a first thread 151A′ and a second thread 151B′, that intersect at multiple locations, and at each intersection an over and under property is associated with the respective first and second threads 151A′, 151B′. In the illustrated embodiment, the fabric element 150′ is defined by a plurality of thread modules 420A, 420B, 420C, similar to those depicted in the illustrated embodiment of FIG. 14 with the exception of absence of rectangular thread modules.

The thread 422 of each thread module 420A, 420B, 420C shown in the illustrated embodiment is physically manifested as a thread 151′. As discussed herein, a digital model of the plurality of thread modules 420 may be physically manufactured. Although the fabric element 150′ is shown substantially planar, it should be understood that the digital model of the thread modules 420 and threads 422 may be translated from a planar configuration (e.g., UV coordinates) to a shape similar to the 3-D contoured surface 162. It is noted that in translating from UV coordinates to a 3-D contoured surface 162, thread modules 420 may not be apparently adjacent to each other in UV space, such as depicted in the illustrated embodiment of FIG. 20 but associated with each other and actually adjacent to each other in X, Y, Z space.

III. Footwear or Garment

An article of footwear 200 incorporating the fabric element 150, 150′ in accordance with an embodiment of the present disclosure is shown in FIG. 10. The article of footwear 200 includes an upper 212 and a sole 214. The article of footwear 200 optionally includes a midsole 218 fitted between the upper 212 and the sole 214. Although the present disclosure is described in the context of a conventional mid-height boot (e.g., 6 inches), the present disclosure is not so limited. The article of footwear 200 in which the fabric element 150, 150′ is incorporated may vary over a wide range of footwear. For example, an embodiment according to the present disclosure may involve full-height boots (e.g., 8-10 inches), hiking shoes, running shoes, pac boots, ski boots or essentially any other footwear that includes a sole and an upper and the fabric element 150, 150′.

As noted above, the footwear 200 of FIG. 10 generally include an upper 212 and a sole 214. The fabric element 150, 150′ may be incorporated into footwear that includes essentially any upper construction and any sole construction. However, for the purposes of disclosure, the present invention is described in the context of a conventional mid-height work boot. For example, in this embodiment, the article of footwear 200 is a 6 inch work boot. In the illustrated embodiment, the upper 212 includes an outer layer 240, which may be manufactured from one or more pieces of material that are joined together to form a foot containing space. The one or more pieces of material may include one or more fabric elements 150, 150′. The outer layer 240 may be manufactured from a single type of material or from a combination of two or more materials. For example, in the illustrated embodiment, the outer layer 240 includes a primary material, such as leather (e.g., full grain leather), and a secondary material, such as the fabric element 150, 150′ or nylon fabric (e.g., 1680 denier nylon fabric) that are joined together by sewing and/or adhesive. The upper 212 may also include internal lining materials. The upper 212 may include additional components, such as a heel counter, a composite toe and/or internal padding. For example, in the illustrated embodiment, the upper 212 includes padding in the collar 278 where the top portion of the upper 212 will engage the wearer's leg. The bottom of the upper 212 may be closed using an insole board, such as lasting board. For example, the upper 212 may be fitted over a last and its bottom peripheral edge may be secured to the lasting board using conventional techniques and apparatus. The upper 212 may be closed using alternative constructions, such as other types of lasting boards.

In one embodiment, the upper 212 may be formed entirely of the fabric element 150, 150′ as a unitary upper with edges joined together along the bottom from the heel to the toe. The edges may be joined directly or may be joined together indirectly via a Strobel board.

The fabric element 150, 150′ according to one embodiment may include one or more apertures or openings that provide ventilation or access for other elements. As an example, the fabric element 150, 150′ may include lace openings or apertures. In another example, the fabric element 150, 150′ may include extended channels through which laces or other elements may be disposed. The extended channel in one embodiment may extend partially from the sole 214 to the opening in the upper 212 that accepts the foot within the void defined by the upper 212. The extended channel in one configuration may accept loops anchored near the sole 214 with a loop near the opening or upper 212 or near the tongue to accept laces.

In the context of ventilation, the fabric element 150, 150′ may include an area (e.g., the second area 154) with a more loosely packed textile pattern that facilitates ventilation over another more densely packed area (e.g., the first area 152). In this way the two areas may have a different textile configuration. As an example, the more loosely packed textile pattern may appear more mesh-like or partially see-through with ventilation capabilities, whereas the more densely packed area may present a more opaque looking fabric. This configuration may enable ventilation areas to be designed into the fabric element 150, 150′ in a seamless manner.

The article of footwear 200 may include essentially any sole construction. In the illustrated embodiment, the sole 214 generally includes a midsole 242 and an outsole 244. Generally speaking, the midsole 242 provides cushioning for the wearer's foot and the outsole 244 provides durability and traction for the article of footwear 200. Although the midsole 242 may vary from application to application, the midsole 242 of the illustrated embodiment is manufactured from a relatively resilient material selected to provide the article of footwear 200 with a desired level of cushioning. For example, the midsole 242 may be formed from ethyl vinyl acetate (“EVA”) or polyurethane. The midsole 242 generally includes an upper surface and a lower surface. The upper surface is configured to be secured to the lasting board, for example, by adhesives, and the lower surface is configured to be secured to the outsole 244, for example, by adhesives. The midsole 242 may be secured to the upper 212 using other techniques and apparatus. For example, the midsole 242 may be molded directly onto the bottom of the upper 212 in direct contact with the lasting board.

In this embodiment, the outsole 244 is secured to the lower surface of the midsole 242, and is configured to engage the ground and form the wear surface of the article of footwear 200. The outsole 244 may be manufactured from a conventional outsole material that is selected to provide the desired balance between comfort, wear, traction and cost. For example, the outsole 244 may be manufactured from a conventional rubber compound or from other suitable wear-resistant materials. The outsole 244 may include treads and/or lugs or be otherwise configured to enhance traction. The outsole 244 may be manufactured using injection or pour molding techniques utilizing conventional molding apparatuses. In the illustrated embodiment, the outsole 244 is secured to the lower surface of the midsole 242 using cement or other suitable adhesives. The midsole 242 and outsole 244 may be secured using alternative techniques, if desired. For example, the midsole 242 may be integrally molded onto the outsole 244 or vice versa.

The sole 214 may also include a sock liner. The sock liner may be positioned inside the bootie to provide cushioning for the foot. In the illustrated embodiment, the sock liner is perforated to allow airflow through the sock liner. For example, the sock liner may be covered with an array of small apertures that extend vertically through the sock liner. In the illustrated embodiment, the apertures cover substantially the entire surface of the sock liner. Alternatively, the apertures may exist only in select regions of the sock liner. The sock liner may include alternative structure for allowing air to flow through the sock liner.

The fabric element 150, 150′ may be incorporated into any aspect of the footwear, including any of the features described herein. The fabric element 150, 150′ may be cut (e.g., die cut) according to the configuration of the footwear. Alternatively, the fabric element 150, 150′ may be manufactured by the additive manufacturing device 130 with finished edges so that the fabric element 150, 150′ is ready for use in constructing the footwear with no significant modifications. For instance, the fabric element 150, 150′ may be the sock liner, manufactured according to one embodiment described herein as a unitary piece and incorporated into the footwear 200.

In one embodiment, the fabric element 150, 150′ may be manufactured by additive deposition on all or a portion of the footwear 200. For instance, the fabric element 150, 150′ may be deposited on the footwear 200, which may be in an incomplete or partial form. The footwear 200 or a portion thereof may be disposed on a footwear last and positioned relative to a nozzle of the additive manufacturing machine from which material can be deposited according to the 3-D model of the fabric element 150, 150′. The footwear last may provide a form for the footwear 200 as it is being manufactured or manipulated for manufacture.

The fabric element 150, 150′ may be deposited on an existing aspect of the footwear element (or the footwear last) in accordance with one embodiment by manipulation of the footwear last and/or the nozzle of the additive manufacturing device 130 in 3-D space. In one embodiment the deposition axis for material deposited on the footwear 200 may vary—e.g., the buildup axis of deposited material may change as the material is deposited on the footwear 200. An example of this manufacturing method is provided in U.S. Provisional Application No. 62/511,626, filed May 26, 2017 to Christopher Loveder, entitled ARTICLE OF FOOTWEAR, and U.S. application Ser. No. 15/964,686, filed Apr. 27, 2018 to Christopher Loveder, entitled ARTICLE OF FOOTWEAR, both of which are incorporated herein by reference in their entirety.

The fabric element 150, 150′ may be integrally manufactured with other aspects of the footwear 200, such as aspects generated by additive manufacturing techniques. For instance, the fabric element 150, 150′ may be integrally joined with a less resilient or harder lace aperture support manufactured by additive deposition of material from the nozzle of the additive manufacturing machine. Additional or alternative aspects of the footwear 200 that may be integrally manufactured with a seamless coupling between the fabric element 150, 150′ include a midsole component, outsole component, upper element (e.g., an instep region formed of non-threaded material) and heel section. In one embodiment, the upper of the footwear 200 may be formed in a unitary manner (optionally with no seams) from additive manufacturing techniques including one or more fabric elements 150, 150′ and one or more non-threaded or non-fabric element aspects, all or some of which may be additively manufactured with the same machine. In another embodiment, the upper of the footwear 200 may include one or more fabric elements 150, 150′ and one or more aspects manufactured according to techniques other than additive manufacturing, including, for example, injection molding and mechanically manipulated yarn.

In one embodiment, the fabric element 150, 150′ may be configured with a thread arrangement that provides resiliency substantially in a first direction and resistance along a second direction transverse to the first direction. For instance, the fabric element 150, 150′ may be disposed near the medial side of the footwear 200 in proximity to a toe region where the footwear flexes as a person walks. This wear area of the footwear may include the fabric element 150, 150′, which may be configured to allow resiliency in the direction of compression and tension (e.g., along the longitudinal axis of the footwear 200), whereas the thread arrangement of the fabric element 150, 150′ may provide increased strength along a transverse direction to the direction of compression and tension. Because the thread arrangement of the fabric element 150, 150′ may be customized according to one or more embodiments herein, the direction of resiliency may be varied from region to region of the fabric element 150, 150′. This variance may enable the fabric element 150, 150′ to provide strength along a direction of compression and tension in use of the footwear, where the direction of compression and tension may be non-linear along the length of the footwear 200. In one configuration, resiliency and strength in different directions may be achieved by utilizing different materials or material properties, or both, for the warp and weft threads of the fabric element. For instance, the warp threads may be constructed for low elasticity, whereas the weft threads may be much more elastic, enabling expansion or high elasticity along a direction of the weft threads but low elasticity along the direction of the warp threads. As described herein, the fabric element 150, 150′ may include more than one type of material and/or more than one type of thread arrangement to achieve mechanical properties consistent with a functional operation of the fabric element 150, 150′ in the footwear (e.g., cushioning near an ankle opening, strength in a heel counter, strength along a direction of force applied by laces, and elasticity in areas of that flex). For instance, a material type of filament provided to the additive manufacturing machine may vary during manufacture of the fabric element 150, 150′ in accordance with the application parameters.

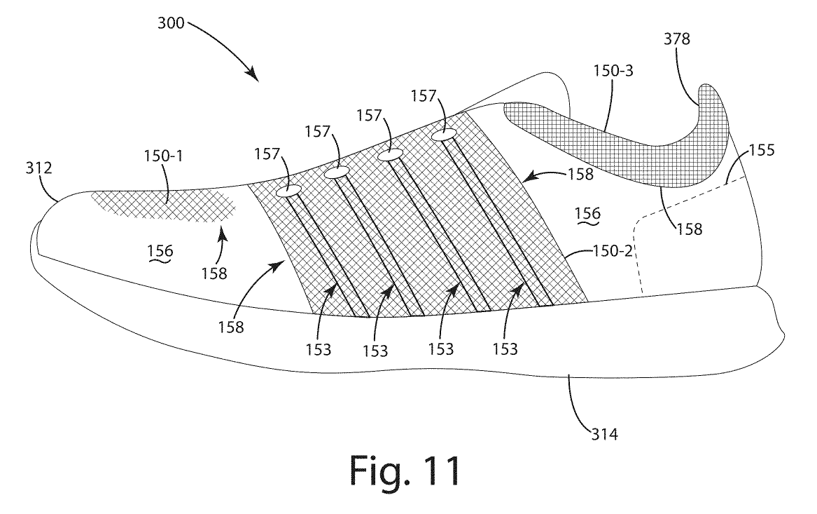

An article of footwear according to one embodiment is depicted in the illustrated embodiment of FIG. 11, and generally designated 300. The footwear 300 is similar to the footwear 200 depicted in the illustrated embodiment of FIG. 10. For instance, the footwear 300 includes a sole 314 (with a midsole and an outsole) and an upper 312, similar respectively to the sole 214 and upper 212 of the footwear 200. The footwear 300 in the illustrated embodiment is shown with several types of fabric elements 150, 150′ according to one or more embodiments described herein. It should be understood that the footwear 300 may include more or few of the fabric elements 150, 150′ in the illustrated embodiment, and is not limited to the configuration of fabric elements 150, 150′ shown and described herein. For instance, the fabric element 150, 150′ that defines the ankle opening 378 may not be present. Additionally or alternatively, a fabric element 150, 150′ may be incorporated into the toe box of the footwear 300.

In the illustrated embodiment, the toe area of the upper 312 (e.g., forward of the throat) may include an integrated fabric element 150-1 that is joined to an adjacent component 156 of the upper 312 via a joint 158 that is seamless. The adjacent component 156 may be manufactured with additive manufacturing techniques similar to the fabric element 150-1. For example, the adjacent component 156 in the illustrated embodiment is a 3-D printed material without threads (although it may be configured differently as a fabric element 150, 150′). Alternatively, the adjacent component 156 may be manufactured according to a different technique, such as injection molded polymer, mechanically manipulated yarn with finished edges, die cut fabric, or cut leather, or a combination thereof.

The medial side of the footwear 300 is shown in the illustrated embodiment of FIG. 11 with a second fabric element similar to an embodiment of the fabric element 150, 150′ and designated 150-2. The second fabric element 150-2 may form part of the medial side and may be joined with adjacent components 156 of the footwear 300. The second fabric element 150-2 may also be integrally joined with the lace apertures 157, which along with the second fabric element 150-2 may be manufactured by the additive manufacturing device 130. Additional support elements or lace supports 153 may be integrated into the second fabric element 150-2 along with the lace apertures 157. The lace supports 153 may be deposited with the additive manufacturing device 130 and optionally integral to the second fabric element 150-2. The lace supports 153 in another embodiment may be provided as separate components about which the second fabric element 150-2 is deposited or disposed in a layer separate from the second fabric element 150-2.

The ankle opening 378 of the footwear 300 may be constructed of a third fabric element similar to an embodiment of the fabric element 150, 150′ and designated 150-3. In the illustrated embodiment, the fabric element 150-3 is based on a spacer mesh configuration in which first and second surfaces separated by a space in which threads are present to support spacing between the first and second surfaces. Conventional spacer mesh as described herein is generally planar in structure with the first and second surfaces spaced apart from each other, and therefore one of the surfaces may have a tendency to kink or crease when shaped to provide curvature. In contrast, the fabric element 150-3 may be digitally modeled to conform to such curvature and manufactured to conform to the curvature with the additive manufacturing device 130. This way, the tendency to kink or crease can be substantially avoided. The spacer mesh configuration of the third fabric element 150-3 in the illustrated embodiment may provide cushion or give in the area proximal to the ankle opening 378, thereby providing a degree of comfort for a foot or ankle in this area. In the illustrated embodiment, the third fabric element 150-3 may be joined with the adjacent component 156 of the footwear 300 via the joint 158. The joint 158 in this embodiment may be seamless such that the adjacent component 156 is formed of an additively deposited material in a manner similar to the third fabric element 150-3.

The fabric element 150, 150′ described with respect to several of the illustrated embodiments is shown generally as an outer layer of the footwear 300 and/or as a single layer of the footwear 300. It should be understood, however, that the present disclosure is not so limited. The fabric element 150, 150′ in accordance with one embodiment may be modeled and constructed as an internal layer of the footwear 300, such as the heel counter 155 shown in phantom in the illustrated embodiment. Additionally, or alternatively, the fabric element 150, 150′ may be disposed in a layered relationship with at least one other fabric element 150, 150′—e.g., the fabric element 150, 150′ may be layered adjacent to the other fabric element 150, 150′, or the fabric element 150, 150′ may be adjacent to at least one intermediate layer disposed between the fabric element 150, 150′ and the other fabric element 150, 150′. In a more specific example, the fabric element 150, 150′ may be a liner or batting of the upper 312 and the other fabric element 150, 150′ may be the outer layer of the upper 312.

In one embodiment, first and second fabric elements 150, 150′ of the footwear may be completely or partially joined at adjacent surfaces. This type of joint as opposed to an edge joint may provide a layered effect. The joint may be based on fusing between one or more threads of each of the first and second fabric elements 150, 150′. In one example, select threads or a select area, or both, of the first fabric element 150, 150′ may be fused with one or more select threads or a select area, or both, of the second fabric element 150, 150′.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

The embodiments of the invention in which an exclusive property or privilege is claimed are defined as follows:

1. A method of manufacturing an article of footwear comprising:
additively depositing material to form a fabric element, the fabric element having a plurality of threads that form at least one texture; and
incorporating the fabric element into the article of footwear.

2. The method of claim 1 wherein the plurality of threads form a first texture in a first area and a second texture in a second area, the first texture being different from the second texture to impart varying textures to a surface of the fabric element.

3. The method of claim 2 wherein the first area is formed of a first stitch or weave configuration, wherein the second area is formed of a second stitch or weave configuration.

4. The method of claim 2 wherein the first area is formed of a first stitch configuration, and wherein the second area is formed of a second stitch configuration, and wherein at least one of the first stitch configuration and the second stitch configuration is a knit construction formed by additively depositing material.

5. The method of claim 1 comprising:
generating a three-dimensional model of the fabric element with digital representations of the plurality of threads;
digitally slicing the three-dimensional model into a plurality of two-dimensional layers that, when stacked, form the three-dimensional model; and
additively depositing the respective two-dimensional layers to form the fabric element.

6. The method of claim 5 comprising:
depositing a first type of the material that is insoluble in the presence of an agent; and
depositing a second type of material that is soluble in the presence of the agent.

7. The method of claim 6 wherein the first type of material forms the plurality of threads.

8. The method of claim 5 wherein the three-dimensional model conforms to a contoured three-dimensional surface.

9. The method of claim 8 comprising texturing the three-dimensional model according to a normal map, the normal map including texture details absent from the contoured surface.

10. The method of claim 1 wherein the fabric element appears woven or knit from the plurality of threads.

11. A method of manufacturing an article of footwear comprising:
translating a digital representation of a textile element to a three-dimensional fabric element, the textile element including threads arranged according to a pattern;
additively depositing material to form the three-dimensional fabric element; and
incorporating the three-dimensional fabric element into the footwear.

12. The method of claim 11 wherein said translating includes mapping the digital representation of the textile element to a contoured surface such that the three-dimensional fabric element conforms to the contoured surface.

13. The method of claim 12 comprising texturizing the three-dimensional fabric element according to a normal map, the normal map including texture details absent from the contoured surface.

14. The method of claim 11 wherein the three-dimensional fabric element includes a plurality of threads that form at least one texture.

15. The method of claim 14 wherein the plurality of threads form a first texture and a second texture that differs from the first texture.

16. An article of footwear comprising:
an upper incorporating a three-dimensional printed fabric element having a first area and a second area, the three-dimensional printed fabric being formed by deposition of material and including a plurality of threads, the first area being formed of a first texture configuration, and the second area formed of a second texture configuration that is different from the first texture configuration; and
a sole structure secured to the upper.

17. The article of footwear of claim 16 wherein the first area is formed of a first stitch or weave configuration, and the second area is formed of a second stitch or weave configuration.

18. The article of footwear of claim 16 wherein the first area is formed of a first stitch configuration, and wherein the second area is formed of a second stitch configuration, and wherein at least one of the first stitch configuration and the second stitch configuration is a knit construction formed by additively depositing material.

19. The article of footwear of claim 17 wherein the first area and the second area are defined by a weave pattern in which warp and weft threads interlace to provide the three-dimensional printed fabric with the first texture configuration in the first area and the second texture configuration in the second area.

20. The article of footwear of claim 17 wherein the first area is defined by arranging more than one thread in the first area according to the first stitch configuration, and wherein the second area is defined by arranging more than one thread in the second area according to the second stitch configuration.

21. The article of footwear of claim 16 wherein the three-dimensional printed fabric element forms at least a portion of an exterior surface of the upper.

22. The article of footwear of claim 16 wherein the three-dimensional printed fabric conforms to a contoured surface such that the three-dimensional fabric is shaped during deposition of the material.

23. The article of footwear of claim 22 wherein the three-dimensional printed fabric is texturized according to a normal map.

24. A garment comprising:
a three-dimensional printed fabric formed by deposition of material to form a three-dimensional contoured shape, the three-dimensional printed fabric including a plurality of threads.

25. The garment of claim 24 wherein the plurality of threads form a first texture and a second texture that differs from the first texture.

26. The garment of claim 24 wherein the three-dimensional printed fabric includes a first area and a second area, wherein the first area includes the first texture and the second area includes the second texture.

27. The garment of claim 25 wherein the three-dimensional printed fabric is texturized according to a normal map.

28. The garment of claim 24 wherein the three-dimensional printed fabric is generated from a three-dimensional model defined by digital representations of the plurality of threads.

29. The garment of claim 28 wherein the three-dimensional model is based on a translation of digital textile representation to the three-dimensional contoured shape.
